(19) United States
(12) Patent Application Publication
(10) Pub. No.: US 2009/0017338 A1
(43) Pub. Date: Jan. 15, 2009

(54) Fuel cell stack for vehicle

(75) Inventor: Jae Jun Ko, Gyeonggi-do (KR)

Correspondence Address: Edwards Angell Palmer & Dodge LLP, P.O. Box 55874, Boston, MA, 02205, US

(73) Assignee: Hyundai Motor Company, Seoul (KR)

(21) Appl. No.: 11/999,936

(22) Filed: Dec. 6, 2007

(30) Foreign Application Priority Data
Jul. 13, 2007 (KR) 10-2007-0070599

(51) Int. Cl. H01M 8/02

(52) U.S. Cl. 429/12

(57) ABSTRACT

A fuel cell stack for a vehicle is disclosed. The fuel cell stack for a vehicle includes a plurality of cells, a separator, a current collector, and an end plate. The end plate is arranged on each of the both end sides of the stack comprises a plurality of grooves formed in a front surface thereof which contacts the current collector.

### CROSS-REFERENCE TO RELATED APPLICATION

This application claims the benefit under 35 U.S.C. §119(a) on Korean Patent Application No. 10-2007-0070599, filed on Jul. 13, 2007, the entire contents of which are incorporated herein by reference.

### BACKGROUND

1. Technical Field

The present invention relates to a fuel cell stack for a vehicle which can prevent or reduce deterioration of a cold start performance.

2. Background Art

Generally, a Polymer Electrolyte Membrane Fuel Cell (PEMFC) shows a high performance at a temperature between room temperature and 80° C., and its performance is lowered at a low temperature as a reaction activation and ion conductance of an electrolyte membrane are decreased.

Particularly, if an outside temperature falls below 0° C. and so a temperature of a fuel cell stack mounted on a vehicle falls below the freezing point of water, water used to activate an electrode and transfer a hydrogen ion in an electrolyte membrane may be frozen, which can lower the conductance and in turn reduce overall performance of the fuel cell. For this reason, when a fuel cell starts at a low temperature, it is very important to rapidly raise the temperature to 0° C. or higher to warm an inside of a fuel cell stack.

The amount of heat generated by operation of a fuel cell is in proportion to the amount of an electrical current generated and is in inverse proportion to a voltage maintained at that time. That is, in order to raise the temperature to 0° C. or higher as soon as possible during a cold start, the maximum amount of heat should be generated. To this end, a large amount of electrical current should be generated while maintaining a voltage as low as possible.

In case of a fuel cell stack in which a plurality of cells are stacked, a large amount of electrical current can be stably generated when a voltage of each cell is constantly maintained.

If a voltage is not uniform, an inverse voltage may occur in a fuel cell which maintains a low voltage, and so it is difficult to generate a large amount of electrical current. As a result, the other cells have a high voltage, and thus the total amount of heat generated is not enough.

The temperature of a fuel cell stack during a cold start is raised by heat generated in each cell. As the temperature of a fuel cell stack is raised, more amount of electrical current can be generated, so that it is possible to raise the temperature of a fuel cell stack more rapidly.

In a fuel cell stack, each of the cells (i.e., end cells) positioned at the both end sides of the stack is in contact with an end plate. No heat is generated by the end plate. A portion of the heat of the end cells will be transferred to the end plate. As a result, a problem occurs that the temperature increase of the cells positioned at the both end sides of the stack is less than that of the cells positioned between the end cells.

FIG. 6 is a graph illustrating a temperature deviation of a cell during a cold start of a conventional fuel cell stack, and FIG. 7 is a graph illustrating the performance of each cell during a cold start of a conventional fuel cell stack.

As shown in FIG. 6, the end cells have lower temperature than the cells positioned between the end cells, which causes a reduced amount of electrical current generated. As shown in FIG. 7, the performance of the end cells is raised more slowly than those of the other cells.

That is, the conventional fuel cell stack generates a small amount of heat and thereby delays the time for which a fuel cell stack can reach 0° C. or higher during a cold start.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to solve the aforementioned problems associated with prior art. One object of the present invention is to provide a fuel cell stack which can prevent or reduce a temperature decrease of a fuel cell at or near an end plate thereof.

In a preferred embodiment, the present invention provides a fuel cell stack for a vehicle, which includes a cell, a separator, a current collector and an end plate, wherein the end plate is arranged on each of the both end sides of the stack comprises a plurality of grooves formed in a front surface thereof which contacts the current collector.

In another preferred embodiment, the current collector has a plurality of holes thereon.

In still another preferred embodiment, a heat insulating material is provided in the groove.

In a further preferred embodiment, a heat insulating material is provided in the hole.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

Other aspects of the invention are discussed infra.

### BRIEF DESCRIPTION OF THE DRAWINGS

The above and other features of the present invention will be described in reference to certain exemplary embodiments thereof with reference to the attached drawings in which:

FIG. 1 shows the structure of a fuel cell stack for a vehicle according to a first exemplary embodiment of the present invention;

FIGS. 2a and 2b show the structure of a fuel cell stack for a vehicle according to a second exemplary embodiment of the present invention;

FIG. 3 shows the structure of a fuel cell stack for a vehicle according to a third exemplary embodiment of the present invention

FIG. 4 shows the structure of a fuel cell stack for a vehicle according to a fourth exemplary embodiment of the present invention;

FIGS. 5a and 5b are graphs illustrating cold start results of the fuel cell stack according to a preferred embodiment of the present invention and a prior art fuel stack, respectively;

FIG. 6 is a graph illustrating a temperature deviation of a cell during a cold start of the conventional fuel cell stack; and

FIG. 7 is a graph illustrating the performance of each cell during a cold start of the conventional fuel cell stack.

### DETAILED DESCRIPTION

Reference will now be made in detail to the embodiments of the present invention, examples of which are illustrated in the accompanying drawings, wherein like reference numerals refer to the like elements throughout. The embodiments are described below in order to explain the present invention by referring to the figures.

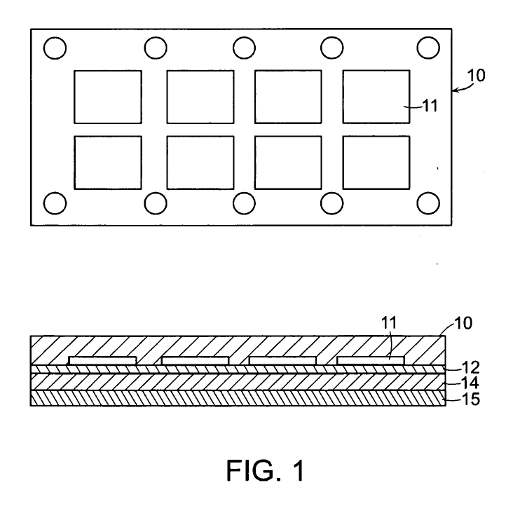

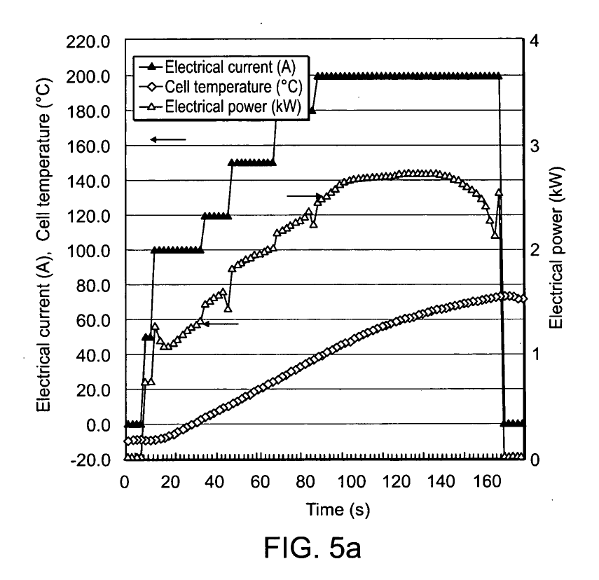

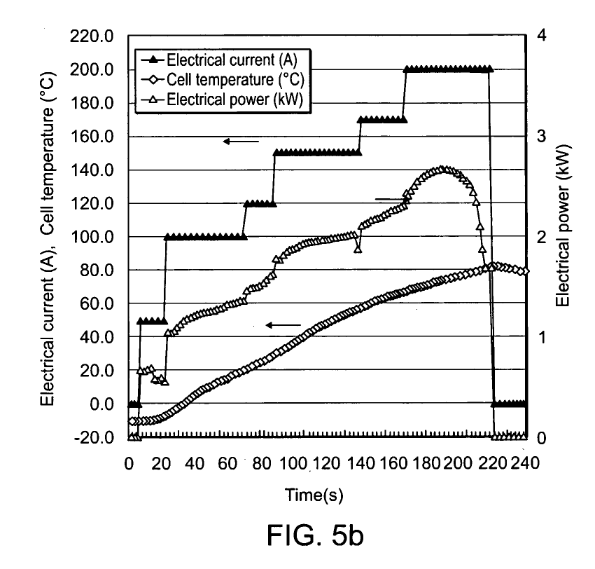

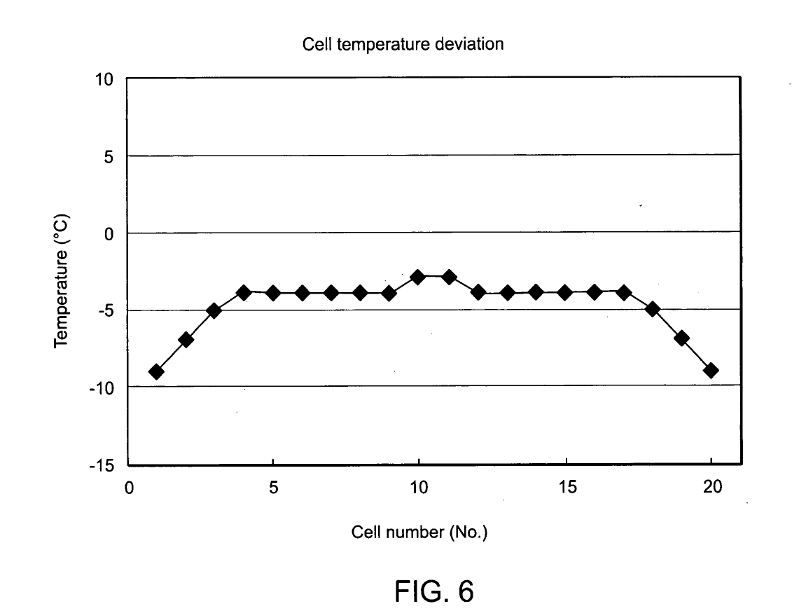

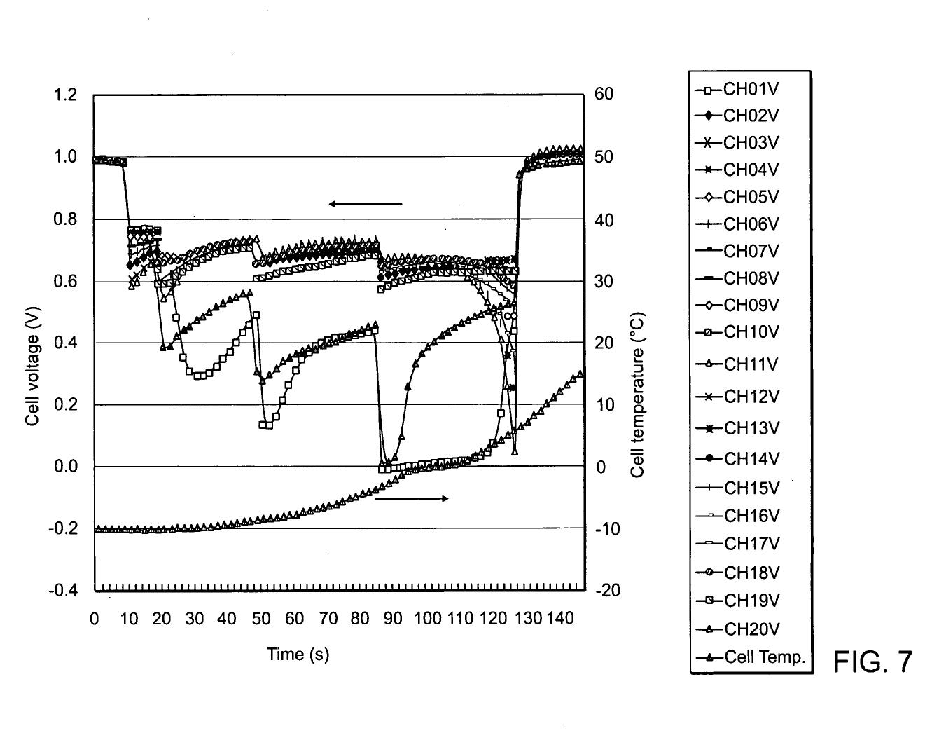

FIGS. 1 to 4 show fuel cell stacks according to exemplary embodiments of the present invention. FIGS. 5a and 5b are graphs illustrating cold start results of the inventive fuel cell stack and the conventional fuel stack, respectively In the fuel cell stacks according to the exemplary embodiments of the present invention, an end plate 10 is arranged on each of the end sides of the stack and the end plate 10 has a minimized area contacting a current collector 12, which prevents a decrease in the overall temperature of fuel cells 15, thereby improving the cold start performance of the fuel cell stack.

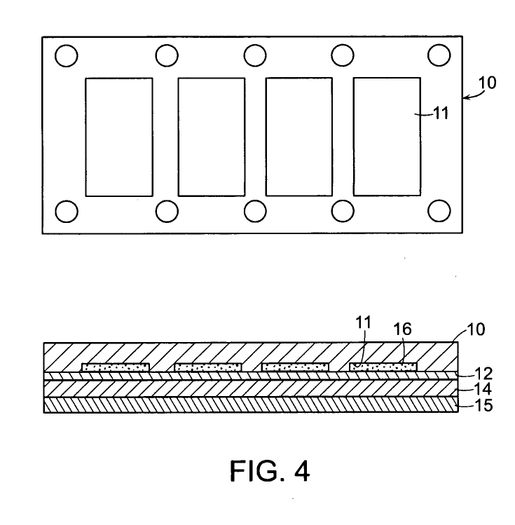

In more detail, preferably, a groove is formed in a front surface of the end plate 10, which contacts the current collector 12 to reduce the amount of absorption of the heat generated in a separator 14. More preferably, a heat insulating material 16 (FIG. 4) is fitted into the groove 11 to insulate the heat generated in the separator 14.

To this end, as shown in FIG. 1, a plurality of grooves 11 may be evenly arranged in a lattice form in a front surface of the end plate, which contacts the current collector 12. A plurality of grooves 11 serve as an air space between the end plate 10 and the current collector 12.

The groove 11 serves to insulate the heat generated in the separator 14 and prevent it from being transferred to the end plate 10.

Although the groove 11 is shown to have a rectangular cross section in FIG. 1, it may have various shapes such as a hexagonal cross section or a diamond-shaped cross section.

Thinner end plate 10 absorbs the smaller amount of the heat generated in the separator. However, if the end plate 10 is too much thin, it is easy to bend. One persons skilled in the art should understand that the thickness of the end plate must be determined in consideration of this factor.

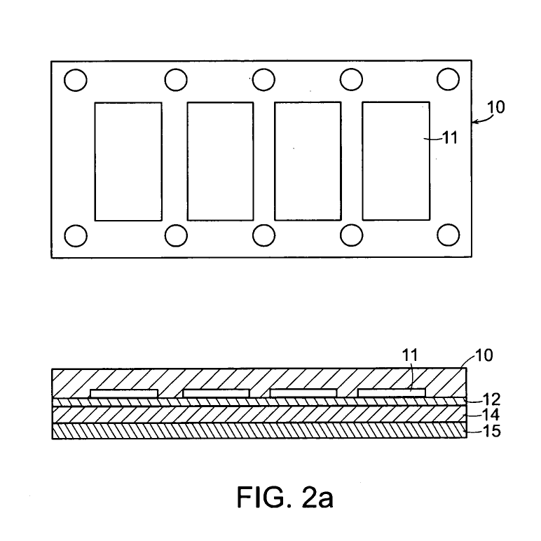

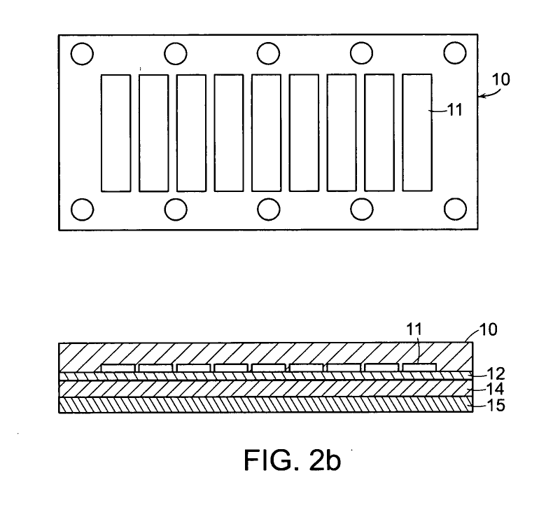

In another preferred embodiment of the present invention, the plurality of grooves 11 may be arranged in a different form. For example, they may be in a stripe form to more secure the air space between the end plate 10 and the current collector 12, as shown in FIGS. 2a and 2b.

The width of the groove 11 of FIG. 2a is greater than the width of the groove 11 of FIG. 2b, whereas the number of the grooves 11 of FIG. 2b is higher than the number of the grooves 11 of FIG. 2a.

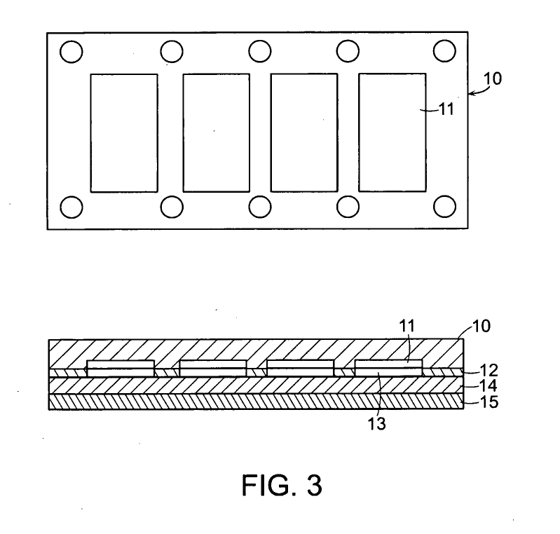

Meanwhile, the current collector 12 as well as the end plate 10 may absorb the heat generated in the separator 14. In order to prevent it, a plurality of holes 13 may be formed also in the current collector 12, as shown in FIG. 3.

Preferably, as shown in FIG. 3, the hole 13 is formed so as to correspond to the groove 11 of the end plate 10, which ensures to minimize the amount of the heat generated in the separator 14 to be absorbed by the current collector 12. However, it should be noted that the shape of the hole 13 is not limited to that shown in FIG. 3. The hole 13 may have various shapes as long as it contributes to insulation in one or other ways.

The heat insulating performance of the air space formed by the groove 11 of the end plate 10 and the hole 13 of the current collector 12 can be lowered if the air space is not tightly sealed from an outside environment. In order to reinforce the heat insulating performance, a heat insulating material 16 having an excellent heat insulating performance may, suitably, be inserted into the groove 11 of the end plate 10 and/or the hole 13 of the current collector 12, thereby efficiently insulating the heat generated in the separator 14.

The heat insulating material 16 may have a shape corresponding to the groove 11 and the hole 13 and is made of a material having an excellent heat insulating performance such as glass fiber, polyurethane form, and polystyrene form.

FIG. 4 shows that the heat insulating material 16 is inserted into the groove of the end plate 10 of FIG. 2a, and the fuel cell stack having such a structure shows a more improved heat insulating performance when the groove 11 is not completely sealed from an outside environment.

In the fuel cell stack with the end plate of the above described structure, since the contact area between the end plate 10 and the current collector 12 is reduced, the amount of the heat generated in the cells arranged inside the separator 14 and absorbed by the end plate 10 is significantly reduced.

Therefore, the temperature decrease of the cells adjacent to the end plate 10 is prevented, and a voltage is constantly maintained in each cell 15, so that the temperature of the fuel cell stack is rapidly raised, leading to an improved cold start performance.

FIGS. 5a and 5b are graphs illustrating the cold start results of the fuel cell stack according to a preferred embodiment of the present invention and a prior art fuel stack, respectively. As can be seen in FIGS. 5a and 5b, it takes about 58 seconds to reach a rated power during a cold start in the present fuel cell stack, whereas it takes about 120 seconds to reach the same in the prior art fuel cell stack.

That is, the prior art fuel stack took twice or more longer time to reach the rated power than the fuel cell stack of the present invention did.

As described above, the fuel cell stack of the present invention has an improved cold start performance since the contact area between the end plate and the current collector is reduced due to the groove formed in the front surface of the end plate which contacts the current collector.

In addition, heat insulating performance can be improved by using the heat insulating material without having to increase the size of the end plate and the current collector.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A fuel cell stack for a vehicle, which includes a cell, a separator, a current collector and an end plate, wherein the end plate is arranged on each of the both end sides of the stack comprises a plurality of grooves formed in a front surface thereof which contacts the current collector.

2. The fuel cell stack of claim 1, wherein the current collector has a plurality of holes.

3. The fuel cell stack of claim 1, wherein a heat insulating material is provided in the groove.

4. The fuel cell stack of claim 2, wherein a heat insulating material is provided in the hole.
